(19) United States
(12) Patent Application Publication
(10) Pub. No.: US 2003/0137678 A1
(43) Pub. Date: Jul. 24, 2003

(54) Device and method for printing figures and data fields from a video

(76) Inventors: Giovanni Ciardiello, Ivrea (IT); Paolo Gallina, Torino (IT)

Correspondence Address: Banner & Witcoff, Eleventh Floor, 1001 G Street NW, Washington, DC, 20001-4597, US

(21) Appl. No.: 10/296,630

(22) PCT Filed: May 22, 2001
(86) PCT No.: PCT/IT01/00259

(30) Foreign Application Priority Data
May 29, 2000 (IT) TO2000A000495

(51) Int. Cl. G06F 15/00; B41J 1/00

(52) U.S. Cl. 358/1.6; 358/1.9

(57) ABSTRACT

A device generates images (50) which are displayed on a monitor (44) and transmitted to a printer (41); the images (50) displayed on the monitor (44) comprise a figure (60) and a data field (61) consisting of clear writings on a dark background, whereas the modified images (52), printed on the physical medium (46), comprise once again the figure (60) and a modified data field (62) consisting of dark writings on a clear background.

### TECHNICAL FIELD

The invention relates to a device for printing electronically generated black or colour images on a physical medium. The images may be generated by a video camera, or by equipment for producing scientific images, topographical images or images for medical diagnosis, by a telecommunications network, by a personal computer, by a machine for reproducing photographs, and the like. The same images are also displayed on a monitor and subsequently printed by means of, for instance, an ink jet printer.

### BACKGROUND ART

FIG. 1 depicts an ink jet printer 41 comprising a scanning carriage 42 having one or more monochromatic or colour printheads 40 on board. Printing is performed on a physical medium 46, normally consisting of a sheet of paper, a sheet of plastic, a fabric or the like. In particular, the paper may be of a type specially treated for the printing of photographs: for simplicity's sake, this will be referred to in the following as “special paper”. Also shown in FIG. 1 are the reference axes:

X axis: horizontal i.e. parallel to the scanning direction of the carriage 42 with the heads 40; y axis: vertical i.e. parallel to the direction of motion of the medium 46 during printing and the line feed function; z axis: perpendicular to the x and y axes, i.e. substantially parallel to the direction of emission of the droplets of ink.

The composition and general mode of operation of a printhead according to the ink jet technology are already widely known in the sector art, and will not therefore be discussed in detail herein, this description instead dwelling more fully on only those features of relevance for the purposes of understanding this invention. In FIG. 2 equipment is shown consisting of an image generator 43 suitable for generating images in analog video format, which comprises a monitor 44, and consisting also of a converter 70 suitable for converting the analog video signal into a digital signal, of a device 71 suitable for processing images in digital form, with the object of rendering the images suitable for printing, of a memory 72 suitable for storing one or more processed images, and of a printer 41 connected to the memory 72. The devices 70, 71 and 72 may constitute self-standing apparatus, as indicated in FIG. 2, or one or more thereof may be incorporated in the image generator 43 or in the printer 41.

As illustrated in FIG. 3, usually an image 50 is presented on the monitor 44 divided into a figure, containing the image true and proper, and a data field, containing alphanumerical information, which is produced in the form of clear writings on a dark background, for the purpose of protecting the phosphors of the monitor 44. When the image 50 is printed on the physical medium 46, the dark background of the data field is disadvantageous, as it involves high level consumption of ink and an extension of the printing time. This invention reveals a device which performs a chromatic modification of the data field in order to be able to print the dark writings on a clear background, and thereby reduce the consumption of ink and the printing time.

### DISCLOSURE OF INVENTION

The object of the present invention is to effect a chromatic modification of the data field in the printing step.

Another object is to reduce the consumption of ink.

Yet another object is to reduce printing time.

The above objects are attained by means of a device and method for printing images from video, characterized as defined in the main claims.

These and other objects, characteristics and advantages of the invention will become clear from the description that follows of a preferred embodiment, provided by way of a non-restricting example, and with reference to the accompanying drawings.

### BRIEF DESCRIPTION OF DRAWINGS

FIG. 1—Represents an axonometric view of an ink jet printer;

FIG. 2—represents an image generator connected to an ink jet printer through image processing and storing devices;

FIG. 3—represents an image consisting of a figure and a data field, as it is presented on a monitor;

FIG. 4—represents a modified image consisting of a figure and a modified data field, as it is printed on a page of the physical medium, according to this invention;

FIG. 5—represents a flow diagram of a chromatic modification operation of the data field.

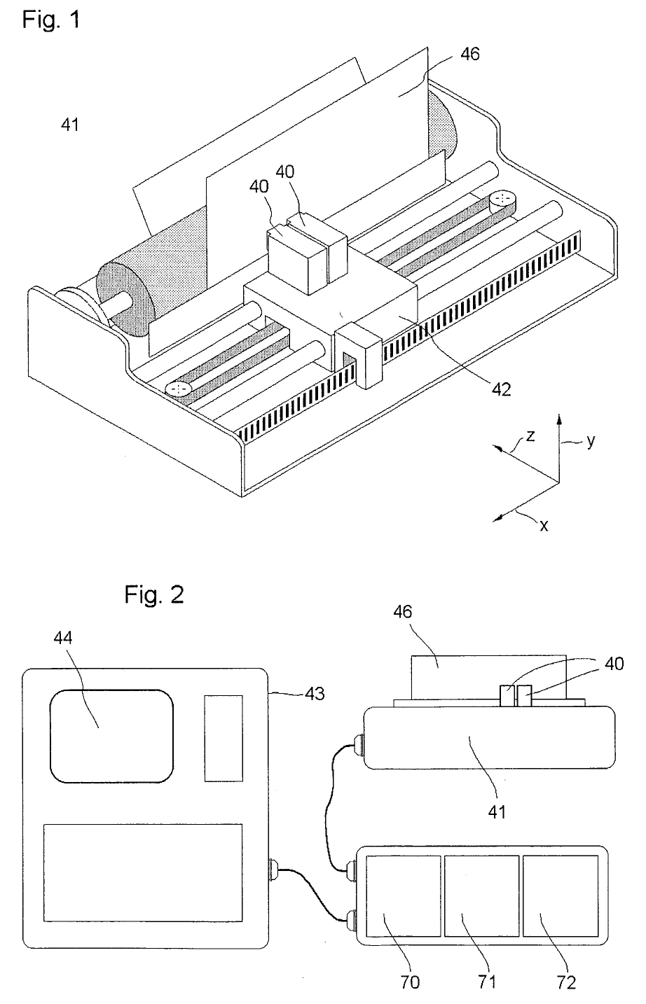

### BEST MODE FOR CARRYING OUT THE INVENTION

In a preferred embodiment, and with reference to FIG. 2, an image generator 43 is taken, consisting for instance of scanning equipment, which produces images, converts them into analog video signals using known techniques and sends them to the monitor 44, which makes them visible in order to permit a medical investigation, where the ultimate objective may be diagnosis. When an image is retained to be of interest, it is processed and sent to a printer 41 which reproduces it on a physical medium 46, usually though not exclusively consisting of special paper. The analog video signals are converted into digital signals by the converter 70, which are processed by the image processing device 71, and stored in the memory 72 using known techniques.

The images printed are generally not suitable for diagnosis, but are produced for the purpose of maintaining a set of documents that complete the patient's clinical file.

The printing and other operations described below are carried out by means of a software or firmware program, or by means of a wired logic circuit, in turn made up of discrete or integrated components, not described because they are known to those acquainted with the sector art.

During the printing, the medium 46 is fed parallel to the y axis after each scan of the carriage 42. The feeding of the medium 46 comprises a motion relative to the heads 40, and thus the principle of this invention is still valid even when the medium 46 is held motionless with respect to the fixed structure of the printer 41, while the heads 40 are fed with a motion substantially parallel to the y axis.

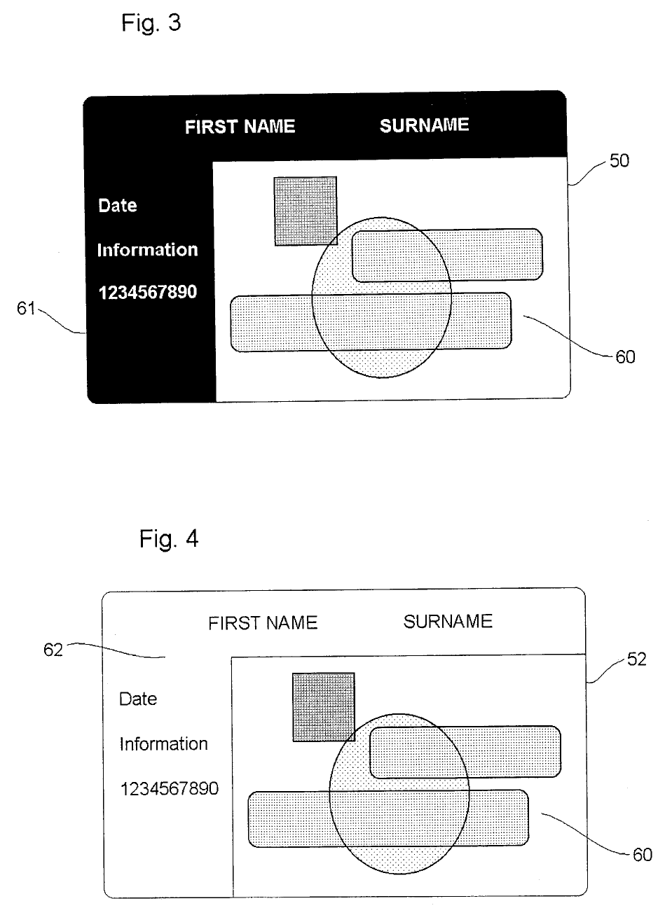

In the description as provided up to this point, it is assumed that the image 50 printed by the printer 41 is substantially equal to the image 50 displayed on the monitor 44. In the following description, on the other hand, the case is taken in which the printer 41 prints a modified image 52, which is modified with respect to the image 50 displayed on the monitor 44 by means of the image processing device 71. Depicted in FIG. 3 is an example of an image 50 presented on the monitor 44. Usually though not exclusively the image 50 is divided into a FIG. 60 and a data field 61, containing alphanumerical information in the form of writings.

In order to protect the phosphors of the monitor 44, it is advantageous to produce the data field 61 having clear writings on a dark background, as those acquainted with the sector art are aware. However when this image 50 is printed on the physical medium 46, the dark background is disadvantageous, because it involves a high consumption of ink and an extension of a time tn, necessary to print a single strip, since the scanning carriage 42 must travel in sequence over the entire background of the data field. To overcome this drawback, the image processing device 71 effects a chromatic modification of the data field 61 and obtains a modified data field 62 having dark writings on a generally clear, and in particular, white, background, as illustrated in FIG. 4, in order to reduce the consumption of ink. The chromatic modification also permits a reduction of the time tn to print a single strip since, if a whole scanning line parallel to the x axis is blank, it may be skipped out and replaced by a feeding movement parallel to the y axis of the physical medium 46, having a lesser time.

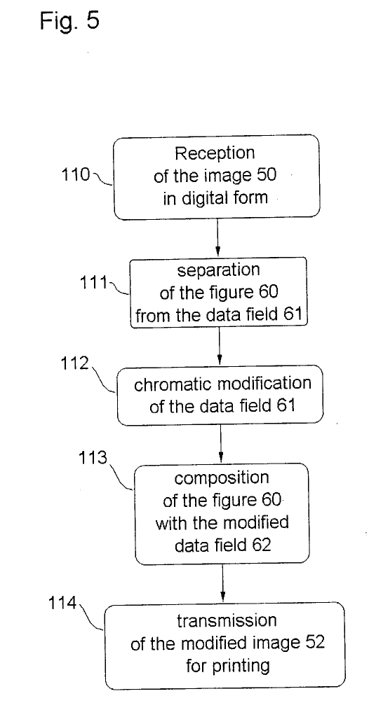

The image processing device 71 may consist of, for instance, a software or firmware program, or a wired logic circuit, in turn consisting of discrete or integrated components. The image processing device 71 effects the following steps, described with the aid of the flow diagram of FIG. 5.

In the step 110 the image processing device 71 receives the image 50 in digital form, containing the data field 61 and the FIG. 60.

In the step 111 the image processing device 71 performs a separation of the FIG. 60 from the data field 61. Usually, though not exclusively, the sequence of digital signals which represents the image 50 does not contain information suitable for recognizing the FIG. 60 and the data field 61; however, the dimensions and the position that the FIG. 60 assumes inside the image 50 are generally known in the form of numerical parameters which are used by the image processing device 71 to perform the separation by means of known techniques. In an alternative solution, the image processing device 71 effects the separation using known image recognition algorithms. In a further alternative solution, the image generator 43 supplies two separate video signals, of which one represents the FIG. 60 while the other represents the data field 61: in this case, the converter 70 generates two sequences of separate digital signals, of which one represents the FIG. 60 and the other represents the data field 61, or generates a single sequence of digital signals which includes the information needed for the subsequent separation of the FIG. 60 from the data field 61, by means of operations known to those acquainted with the sector art. In the step 112, the image processing device 71 effects a chromatic modification of the data field 61, in order to obtain a modified data field 62, which generally presents dark writings on a clear background and in particular black writings on a white background, as illustrated in FIG. 4.

In the step 113, the image processing device 71 effects a composition of the FIG. 60 with the modified data field 62, thereby obtaining the modified image 52. In the step 114, the image processing device 71 sends the modified image 52 to the printer 41 for printing.

1. Equipment for printing images comprising:
a converter (70) for receiving analog video signals representing images (50) consisting of a figure (60) and a data field (61), and for converting said analog video signals into digital signals, said analog video signals being produced by an external image generator (43);
an image processing device (71) suitable for receiving and modifying said digital signals into modified digital signals; and
a printer (41) suitable for receiving said modified digital signals;
characterized in that said image processing device (71) further comprises means suitable for effecting a chromatic modification of said data field (61), so as to obtain a modified data field (62), for composing said modified data field (62) with said figure (60) in order to obtain a modified image (52), and for sending said modified image (52) to said printer (41).

2. Equipment according to claim 1, characterized in that said data field (61) is made up of clear writings on a dark background, and that said modified data field (62) is made up of dark writings on a clear background.

3. Equipment according to claim 2, characterized in that said clear background is white.

4. Equipment according to claim 2, characterized in that said dark writings are black.

5. Equipment according to claim 1, characterized in that said image processing device (71) belongs to said printer (41).

6. Equipment according to claim 1, characterized in that said image processing device (71) is included in said external image generator (43).

7. Equipment according to claim 1, characterized in that said image generator (43) produces images (50) suitable for a medical investigation.

8. Equipment according to claim 7, characterized in that said images (50) are obtained from scanning.

9. Equipment according to claim 7, characterized in that said images (50) are obtained from X-rays.

10. Equipment according to claim 1, characterized in that said printer (41) is of the ink jet type.

11. Equipment according to claim 1, characterized in that said image processing device (71) further comprises means suitable for separating said figure (60) from said data field (61) by means of an algorithm which uses parameters corresponding to the dimensions and the position of said figure (60).

12. Equipment according to claim 1, characterized in that said image processing device (71) further comprises means suitable for separating said figure (60) from said data field (61) by means of an image recognition algorithm.

13. Equipment according to claim 1, characterized in that said converter (70) generates a first sequence of digital signals corresponding to said figure (60) and a second sequence of digital signals corresponding to said data field (61).

14. Equipment according to claim 1, characterized in that said converter (70) generates a sequence of digital signals corresponding to said image (50), said sequence also containing information necessary for a subsequent separation of said figure (60) from said data field (61).

15. Method for printing images comprising the steps of:
receiving at the input of a converter (70) analog video signals representing images (50) from an external image generator (43), said images (50) being made up of a figure (60) and a data field (61); and
converting said analog video signals into digital signals by means of said converter (70);
characterized in that it further comprises the steps of:
performing a chromatic modification of said data field (61), so as to obtain a modified data field (62).
composing said modified data field (62) with said figure (60), in order to obtain a modified image (52);
sending said modified image (52) to a printer (41) suitable for printing said modified image (52) on a physical medium (46).

16. Method according to claim 15, characterized in that it further comprises the step of separating said figure (60) from said data field (61) by means of an algorithm which uses parameters corresponding to the dimension and the position of said figure (60).

17. Method according to claim 15, characterized in that it furthercomprises the step of separating said figure (60) from said datafield (61) by means of an image recognition algorithm.
